(19) United States
(12) Patent Application Publication
(10) Pub. No.: US 2013/0271574 A1
(43) Pub. Date: Oct. 17, 2013

(54) Method And Apparatus For Contactless Data Acquisition In A Vehicle Service System

(71) Applicant: HUNTER ENGINEERING COMPANY, St. Louis, MO (US)

(72) Inventors: Daniel R. Dorrance, Ballwin, MO (US); David A. Voeller, St. Louis, MO (US); Timothy A. Strege, Sunset Hills, MO (US); Nicholas J. Colarelli, III, Creve Coeur, MO (US); Sean D. Reynolds, St. Louis, MO (US)

(73) Assignee: HUNTER ENGINEERING COMPANY, St. Louis, MO (US)

(21) Appl. No.: 13/828,466

(22) Filed: Mar. 14, 2013

Related U.S. Application Data
(60) Provisional application No. 61/623,666, filed on Apr. 13, 2012.
(60) Provisional application No. 61/714,590, filed on Oct. 16, 2012.

(51) Int. Cl. H04N 7/18

(52) U.S. Cl. CPC H04N 7/18
USPC 348/46; 348/135

(57) ABSTRACT

An improved vehicle service system having at least one pattern-projecting, machine-vision sensor for acquiring images of objects and surface during a vehicle service or inspection procedure, and which is configured to process acquired images to identify measurements and/or relative three-dimensional locations associated with the vehicle undergoing service or inspection, vehicle components, surface, or objects in the environment surrounding the vehicle. The improved vehicle service system is further configured to utilized the identified measurements and/or relative three-dimensional locations during a vehicle service or inspection procedure.

### CROSS-REFERENCE TO RELATED APPLICATIONS

The present application is related to, and claims priority from both U.S. Provisional Patent Application Ser. No. 61/623,666 filed on Apr. 13, 2012 and U.S. Provisional Patent Application Ser. No. 61/714,590 filed on Oct. 16, 2012, each of which is herein incorporated by reference.

### STATEMENT REGARDING FEDERALLY SPONSORED RESEARCH

Not Applicable.

### BACKGROUND OF THE INVENTION

The present application is related to vehicle service equipment configured to utilize machine vision to obtain measurements or data associated with a vehicle, vehicle component, an operator, or an object in the environmental vicinity of the vehicle during a vehicle service procedure, and in particular, to equipment and methods for obtaining such measurements or data by observing and processing illumination patterns projected onto the vehicle, vehicle component, operator, or object in the surrounding environment from which the measurements or data is to be acquired.

Vehicle service systems, such as vehicle wheel alignment measurement or correction systems, vehicle wheel balancers, tire changers, vehicle inspection systems, and engine diagnostic systems, or any combination thereof, are configured with a variety of sensors to measure and observe a vehicle undergoing a service procedure or individual components thereof, such as wheel assemblies, body panels, or tire tread surfaces. Vehicle service systems which either have moving parts, such as wheel balancers and tire changers, or which interact with moving components, such as wheel alignment measurement systems and vehicle lift racks, often incorporate sensors for measuring the position or orientation of the moving parts or components. For example, a tire changing system may employ linear potentiometers to measure the extension or retraction of an arm, or a rotary encoder to measure the angular position of a load roller or safety hood. Similarly, a vehicle lift rack may employ a linear potentiometer to measure the extension or retraction of a hydraulic ram for elevating a vehicle-supporting runway surface above the ground. When measuring vehicles or vehicle components, angle sensors or machine vision optical targets are commonly secured to the vehicle or component, from which measurements of position and orientation may be obtained.

In addition, these vehicle service systems typically include an operator interface for displaying, to an operator, various vehicle measurements, specifications, and service procedure instructions, as well as for receiving operator input commands. Conventionally, operator input commands are provided to a vehicle service system through the operator interaction with a graphical user interface (such as a touch-screen, buttons, or an interactive display). Such interfaces require the operator to be physically present at the location of the vehicle service system when inputting commands or reviewing a display of data. Some vehicle service systems attempt to provide an operator with a greater range of freedom during a vehicle service procedure by providing the operator with hand-held remote controls and/or speech recognition to permit verbal commands.

However, once a vehicle service system identifies to an operator the need to carry out a corrective procedure on a vehicle in order to adjust a vehicle component to bring an associated measurement into conformity with a specification value, or to carry out some other vehicle service, the vehicle service system has no means to evaluate the operator's subsequent actions other than by observing resulting changes in the various vehicle measurements.

Similarly, vehicle service systems have no means to monitor the operator's location relative to a vehicle or piece of service equipment when directing the operator to carry out a specific service procedure. For example, current vehicle service systems cannot identify the presence of an operator underneath a raised vehicle on a lift rack when providing an instruction to the operator to lower the vehicle and lift rack, or when receiving a verbal or remote command from an operator to do the same.

Contactless measurement systems for use with machine vision vehicle wheel alignment systems are known, and have been described for example in U.S. Pat. No. 6,894,771 B1 to Dorrance et al., in U.S. Pat. No. 7,336,350 B2 to Dorrance et al., and in U.S. Pat. No. 7,454,841 B2 to Burns, Jr. et al., the disclosures of which are herein incorporated by reference. These systems utilize a variety of techniques to acquire spatial (three-dimensional) information from observed wheels on a vehicle, including observing discrete target-like features present on the surfaces of the observed wheels, utilizing range-finding sensors in conjunction with imaging sensors, and projecting known or encoded patterns onto the wheel surfaces to be observed.

Accordingly, it would be advantageous to enable a vehicle service system to observe a vehicle, vehicle components, or objects in the environment surrounding the vehicle using a contactless machine vision means of acquiring associated spatial measurements or data without the use of range finding systems, identification of discrete target features on the observed surfaces, or the projection of complex known patterns onto the surfaces to be observed. It would be further advantageous to enable the vehicle service system to observe the facial features, gestures, postures, actions, and location of an operator relative to a vehicle undergoing a service procedure in order to improved operator interface functionality and to enhance safety features of the vehicle service system.

### BRIEF SUMMARY OF THE INVENTION

The present disclosure sets forth an improved vehicle service system having at least one pattern-projecting, machine-vision sensor for acquiring topographical images of objects and surface during a vehicle service procedure, and which is configured to process acquired images to identify measurements and/or relative three-dimensional locations associated with the vehicle undergoing service, vehicle components, surface, or objects in the environment surrounding the vehicle. The improved vehicle service system is further configured to utilized the identified measurements and/or relative three-dimensional locations during a vehicle service procedure.

In one embodiment the improved vehicle service system of the present disclosure incorporates a pattern-projecting machine vision sensor configured to observe both movable and stationary objects within a three-dimensional volume of space to identify or measure various objects, vehicle components, people, or surfaces.

In an embodiment of the present disclosure, the pattern-projecting machine vision sensor includes an infrared image projection system capable of projecting at least a random pattern of illuminated points, combined with an associated imaging sensor configured to capture multiple images of the projected pattern under a variety of ambient lighting conditions, and to process the captured images to produce associated spatial or topographical image data.

In a further embodiment of the present disclosure, the vehicle service system incorporates a machine vision sensor configured with a projection system configured to project an illumination pattern onto an object surface, such as a tire tread surface, and an associated imaging sensor which is responsive to the wavelengths of the projected pattern to receive an image thereof on the object surface, from which measurements or data associated with the object surface are determined by a suitably configured processor.

In an further embodiment of the present disclosure, the vehicle service system is configured as a tire service system, such as a vehicle wheel balancer a vehicle tire changing system, or a tire tread depth measurement system (drive-over or remote), and incorporates a machine vision sensor configured with a projection system to project an illumination pattern onto a surface of a tire or wheel assembly undergoing service or inspection, and an imaging sensor which is responsive to the wavelengths of projected pattern to receive an image thereof on the wheel assembly or tire surface, from which measurements or data associated with the wheel assembly or tire surface are determined by a suitably configured processor. These measurements or data may include, for example, a representation of the position and orientation of the wheel assembly mounted to the vehicle service system, or a measure of the remaining tread depth over all, or a portion of, the tire surface.

In a further embodiment of the present disclosure, the vehicle service system is configured as a vehicle wheel alignment system, and incorporates a machine vision sensor configured with a projection system to project an illumination pattern onto a surface of a vehicle undergoing an alignment measurement procedure, one or more wheels of the vehicle, or onto the surface of an object in proximity to the vehicle such as a vehicle supporting surface, lift rack, or runway. The machine vision sensor is further configured with an imaging sensor which is responsive to the wavelengths of projected pattern to receive images thereof on the surfaces of the vehicle or other object, from which measurements or data associated with the surfaces or objects are determined by a suitably configured processor. These measurements or data may include, for example, a representation of the position and orientation of the vehicle, a specific surface of the vehicle, individual vehicle wheels, or the spatial configuration of the vehicle supporting surface.

In a further embodiment of the present disclosure, the vehicle service system is configured to acquire data associated with an operator, and to process the acquired data to identify operator features, gestures, movements, postures, actions, and/or locations relative to a vehicle undergoing a service. The improved vehicle service system is further configured to utilized the identified operator gestures, facial features, postures, actions, and/or locations to identify the operator, carry out operator-directed commands, monitor operator actions, and to ensure operator safety during a vehicle service procedure.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a simplified diagram of a vehicle service system with an imaging sensor having a field of view;

FIG. 2 is an image of an illuminated pattern projected onto the inner surface of a vehicle wheel assembly by a machine vision sensor;

FIG. 3 is an image of an illuminated pattern projected onto the surface of a vehicle wheel assembly by a machine vision sensor;

FIG. 4 is an image of an illuminated pattern projected onto the surface of a tire by a machine vision sensor;

FIG. 5 illustrates a gradient depth map representative of a vehicle wheel rim inner surface with attached imbalance correction weight obtained from processing an image of a projected pattern on a wheel rim surface;

FIG. 6 illustrates a gradient depth map representative of a vehicle wheel assembly obtained from processing an image of a projected pattern, such as shown in FIG. 3;

FIG. 7 illustrates a gradient depth map representative of a tire tread surface obtained from processing an image of a projected pattern on a tire surface;

FIG. 8 is a symbolic representation of a circular hand motion by an operator;

FIG. 9 is a symbolic representation of a waving hand motion by an operator;

FIG. 10 is a symbolic representation of a stationary hand gesture by an operator; and

FIG. 11 is a symbolic representation of a swipe hand motion by an operator.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

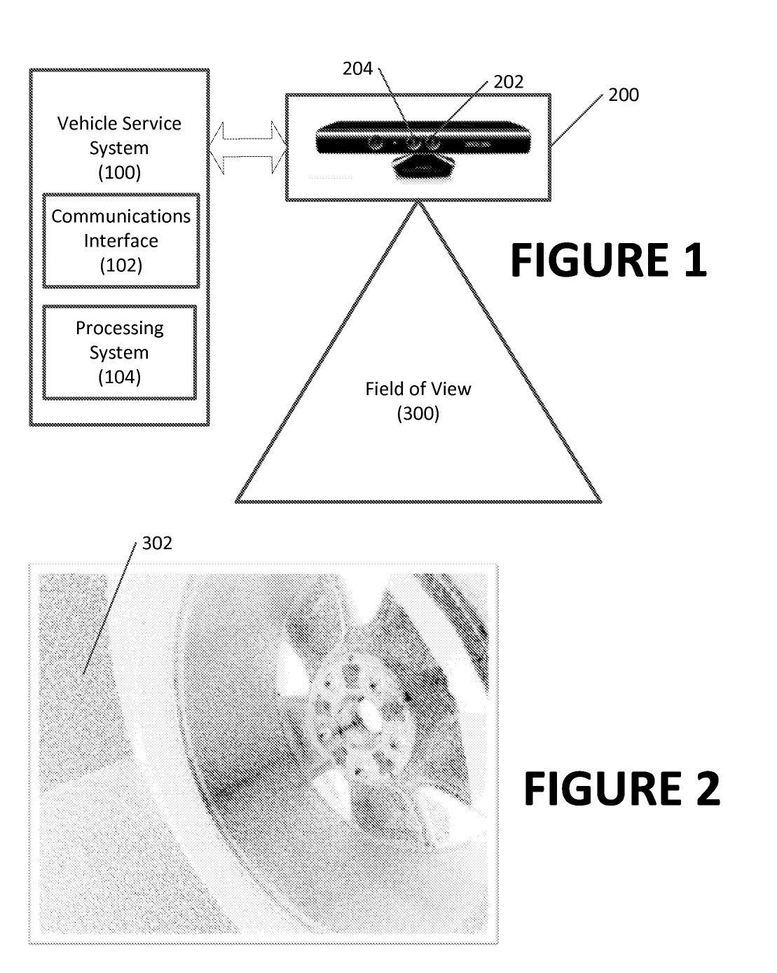

Turning to FIG. 1, a vehicle service system 100 of the present disclosure, which may be any type of vehicle service system such as a vehicle wheel alignment measurement or correction system, a vehicle wheel balancer system, a tire changing system, a vehicle lift, vehicle inspection system, or any combination thereof, is operatively coupled to one or more machine vision sensors 200. Each machine vision sensor 200 is configured to utilize at least one imager element 202 to observe objects and people within a field of view 300 defined by an illuminated pattern projected from a projection source 204 into a three-dimensional volume of space, to produce spatial or topographical image data, which may include relative spatial position and orientation information, such as shown in U.S. Pat. No. 7,584,372 B2 issued to Shylanski et al. on Sep. 1, 2009, and which is herein incorporated by reference.

An exemplary machine vision sensor 200 is the Kinect™, sold by Microsoft Corporation, which is capable of sensing objects and individuals in a volume of three-dimensional space. The sensor in the Kinect device consists of an infrared laser projector 204 combined with a monochrome, 11-bit CMOS sensor 202, which captures video data in three dimensions under any ambient light conditions. The Kinect™ sensor is based on structured light range camera technology developed by PrimeSense Inc., and sold under the trade name PrimeSensor™. Additional disclosure as to the specific image projection and image acquisition functionality of Kinect™ and PrimeSensor™ topographic mapping machine vision sensors for triangulation-based 3D mapping using a projected pattern are described, for example, in PCT International Patent Publications WO 2007/043036, WO 2007/105205, and WO 2008/120217, the disclosures of each of which are incorporated herein by reference. Other exemplary machine vision sensors 200 include the Leap Motion Controller™ precision motion-sensor developed and sold by Leap Motion of San Francisco, Calif., as well as stereo-camera systems having at least two imaging sensors operating as a cooperative pair to observe objects within a common field of view in order to obtain spatial data using known stereoscopic or triangulation methods.

The projection source 204 of the machine vision sensor 200 is configured to project one of a variety of different patterns 302. For example, the projected pattern 302 may be a predetermined or known pattern, random laser speckle pattern, or a pattern of illuminated points which are uncorrelated, such as shown projected onto wheel surfaces in FIGS. 2, 3, and 4. The term “uncorrelated” refers to a projected pattern of points (which may be bright or dark), whose positions are uncorrelated in planes transverse to the projection beam axis. The positions of the points are uncorrelated in the sense that an auto-correlation of the points in the pattern, as a function of transverse shift, is insignificant for any shift larger than the individual point size and no greater than the maximum shift that may occur over the range of depths mapped by the system. In an alternative embodiment, the projected pattern 302 consists of a plurality of illuminated points, but which do not define the vertex points on a regular pattern of geometric shapes. For example, the illuminated points may be disposed in a concentric arrangement (radially symmetric or radially asymmetric) around a central axis of projection. The projected pattern may be a fixed and known pattern, and need not be uniquely generated each time the projection system is activated.

Preferably, the projected pattern 302 does not vary substantially (other than by scale) along the Z-axis within the function depth range in which the spatial or topographical image data is to be acquired. The projected pattern 302 may be projected by the suitably configured projection source 204 at any wavelength which is visible to the associated imager 202. For example, the projected pattern 302 may be composed of random points of infrared light generated by the beam of an infrared laser at the projection source 204 passing through a diffuser or an associated diffractive optical element (DOE), such that the projected pattern is invisible to a human observer, but is highly visible to the associated imager 202 with the use of appropriate filters under most ambient lighting conditions.

To utilize one or more pattern-projecting machine vision sensors 200, the vehicle service system 100 is configured with a suitable communications interface 102 and software instructions for communicating with, and processing image data received from, each machine vision sensor 200 associated with the vehicle service system. The software instructions configure a processing system 104 of the vehicle service system 100 to process acquired images to identify measurements and/or relative three-dimensional locations associated with a vehicle undergoing service, vehicle components, surfaces, objects, or people in the environment surrounding the vehicle. The identified measurements and/or relative three-dimensional locations may then be utilized in a variety of ways, such as during a vehicle service procedure.

Alternatively, all or a portion of the processing of the image data acquired by the machine vision sensors 200 may be carried out by a suitably configured processing system contained within each machine vision sensors 200, and the final or intermediate results communicated to the vehicle service system via the communications interface 102. The specific procedures and techniques for processing image data are generally known in the industry, and the specific methods utilized to process the image data are not intended to limit the scope of the present disclosure. The result of the processing is the identification of the presence of objects and surfaces, as well as the determination of their relative spatial positions and orientations. By acquiring and processing a sequence of images, movement of an object or surface within the three-dimensional spatial volume of the field of view 300 may be identified and observed.

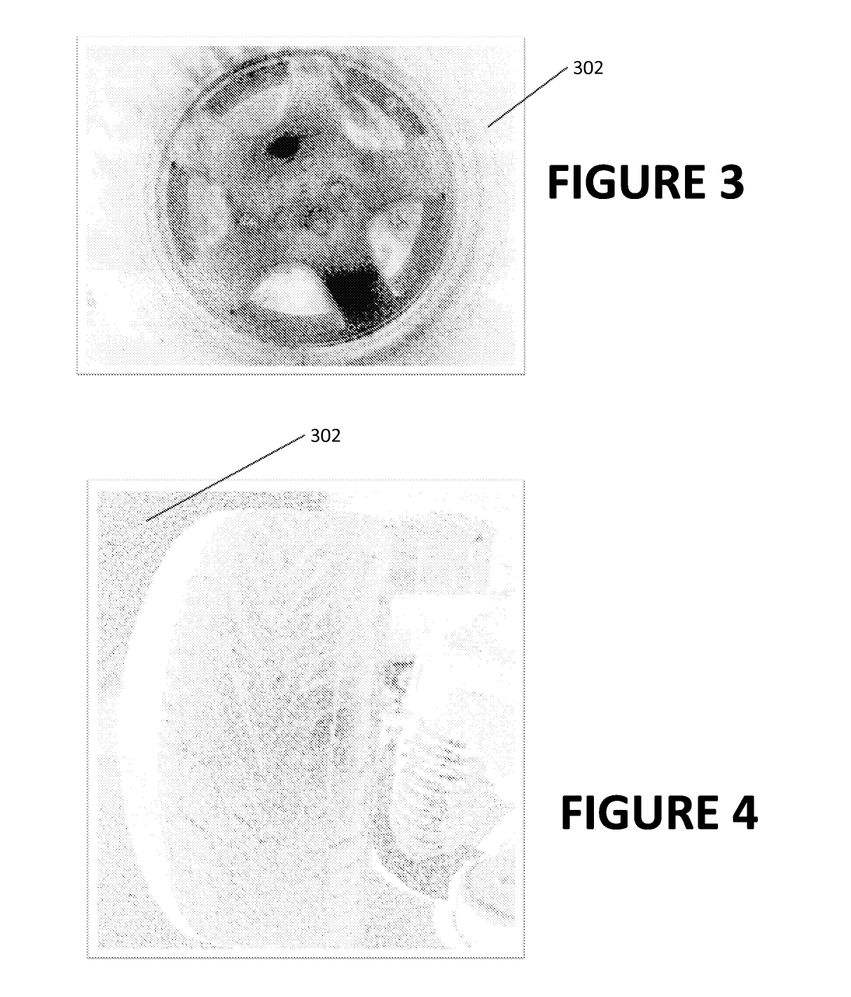

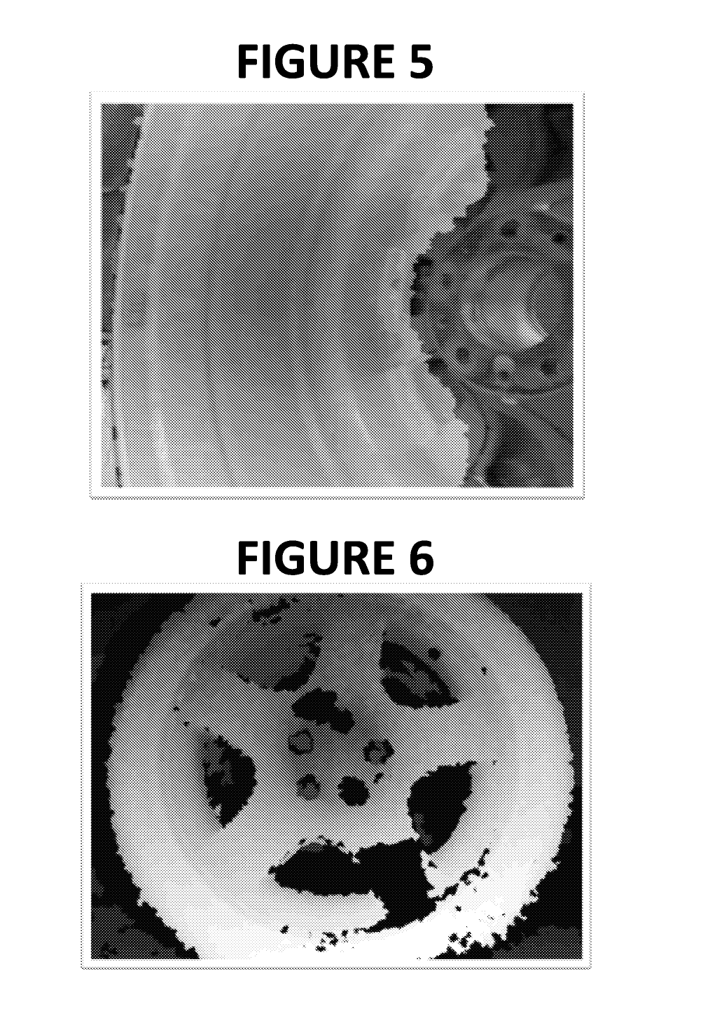

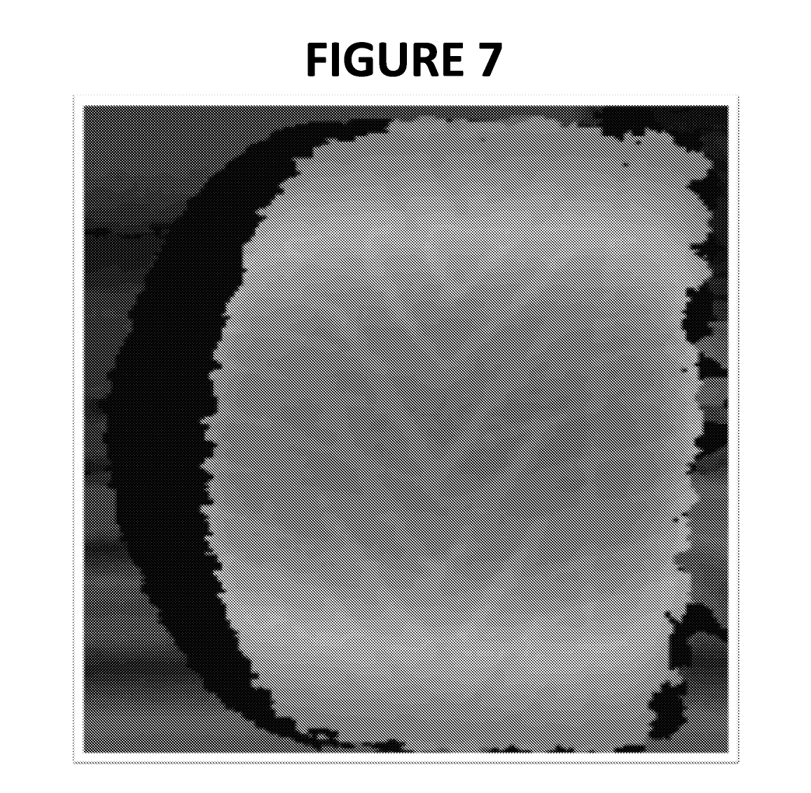

Spatial or topographical data associated with the field of view 300, resulting from the processing of the image data may be in the form of point clouds or gradient representations of depth, such as shown in FIGS. 5-7. This spatial or topographical data may be utilized with a wide range of vehicle service systems 100, including, but not limited to, vehicle wheel alignment systems, vehicle wheel balancers, tire changers, and vehicle diagnostic or drive-through inspection systems. Spatial or topographic image data acquired from the machine vision sensors 200 may be representative of a wide range of specific vehicle features. For example, an observed vehicle feature may include the location or shape of a vehicle body panel. Similarly, an observed feature may include the spatial position and orientation of individual vehicle wheel assemblies as seen in FIGS. 3, 5, and 6, from which various wheel alignment angle measurements may be obtained, such as for use by a vehicle wheel alignment angle audit or drive-through inspection system. The shape or contour of a vehicle wheel rim surface may be observed to identify installed imbalance correction weights, such as on a wheel balancer system, or the depth and pattern of a tire tread may be observed over a portion of a tire surface as seen in FIG. 7, such as for use in a vehicle inspection system, wheel balancer system, or tire changing system.

The spatial or topographical data can be further utilized by the vehicle service system 100 using image analysis software instructions to identify specific features, defects, or objects within the field of view, such as wheel rim damage, valve stem locations, installed imbalance correction weights, vehicle body panel damage, foreign object embedded in a tire tread, etc. The spatial or topographical data may additionally be visually displayed by the vehicle service system 100 to an operator in a format which is useful to convey information, such as by exaggerating a z-axis scale to enhance a display of depth features on a surface, by generating a smooth gradient representation of depth, or as a layer in a composite display which may include color enhancement, text, or other visual indicators.

In addition to observing specific vehicle features, machine vision sensing device may be utilized to produce spatial or topographic image data which is representative of objects and surfaces in the environment surrounding a vehicle or vehicle component undergoing a service procedure. For example, the spatial position and orientation of a vehicle-supporting runway surface may be observed, as well as the location of target surfaces or articulated tools associated with the vehicle service device. Operator position, movement, and gestures may be observed and identified as well, such as by tracking over a sequence of acquired images, and utilized in a variety of ways, such as to provide the operator with warnings or to receive operator input in the form of specific hand-gestures, movements, or the identification of specific objects or locations of interest to the vehicle service system. For example, and operator may be observed to point to a desired location for placement of an imbalance correction weight on a vehicle wheel assembly, or observed to point to the location of a valve stem or other potential obstruction on a vehicle wheel assembly during either a wheel balancing or tire changing service procedure.

The processing system 104 of the vehicle service system 100 may be specifically configured with software instructions to utilize the data acquired by the machine vision sensors 200 to observe objects and people within the field of view 300 to identify various moving elements, including fingers, hands, arms, legs, etc. The software instructions configure the processing system to process acquired images to identify individuals, such as an operator, to identify gestures or postures made by the individuals or operator, actions carried out by the individuals or operator, and/or the location of either the individuals or operator, or other movable objects relative to a vehicle undergoing a service. The processing system 104 may be further configured with software instructions to utilize the identified operator gestures, postures, facial features, actions, and/or locations to carry out operator-directed commands (for example, to provide an alternate form of operator input, replacing a mouse or touch-screen). The processing system 104 may be configured with software instructions to monitor operator actions, to ensure operator safety during a vehicle service procedure, and to ensure proper placement of various movable objects, such as targets, sensors, or imbalance correction weights relative to the vehicle or wheel assembly undergoing service.

For example, during a vehicle wheel alignment measurement procedure, each wheel must be compensated for runout. Not only is it common practice to compensate sensors mounted to the wheels for alignment purposes, it is also common to roll the vehicle a short distance as part of a compensation procedure. The act of rolling the vehicle can change the vehicle's suspension in ways that affect the alignment measurements acquired by the sensors. It is therefore preferred to roll the vehicle by applying force to a rear tire. It is also preferred to identify which rear tire the force is being applied at, because the compensation procedure carried out by the vehicle service device can further be modified to take into account which wheel is being used to roll the vehicle. A vehicle service system 100 configured with a machine vision sensor 200 can identify where the operator's hands are located within the field of view 300 when the vehicle service system 100 detects that the vehicle is moving. Applying software logic, if the identified location of the operator's hands is not at a rear tire of the vehicle, the processing system 104 can be configured with software instructions to respond to the situation by issuing a suitable warning to the operator. The data from the machine vision motion sensor can further determine which side of the vehicle an operator is standing at, so that the compensation procedures can be modified as required to account for the location of the applied rolling force. Additionally, data from the machine vision sensor 200 may be utilized to determine if other operators are assisting in rolling the vehicle, as may be required for heavy vehicles. If an extra operator is not applying force at one of the rear wheels of the vehicle, the processing system 104 can again direct action such as providing additional information to the alignment operator on how compensation is supposed to be done, i.e., where the rolling force is to be applied.

In addition to rolling compensation, there are other vehicle wheel alignment service procedures where the physical location of the operator may be relevant information for the vehicle service system 100. For example, during a vehicle wheel alignment service, there are several alignment procedures that involve steering the vehicle. In these procedures it is important to know if the alignment operator is steering the vehicle from inside or outside of the vehicle. For some procedures it is generally incorrect to steer the vehicle while the operator is sitting in the vehicle because the extra weight of the alignment operator changes the resulting alignment measurements. Other procedures do require or prefer the operator to be located in the vehicle.

A vehicle service system 100 of the present disclosure may be configured with software instructions to utilize the data from the machine vision sensors 200 to determine where the operator is positioned when the vehicle service system 100 detects that the vehicle wheels are being steered. If the operator is located inside the vehicle when steering the vehicle wheels, the processing system 104 is configured to respond by issuing a warning, restarting the procedure, or presenting background information to the operator explaining why they are not supposed to be doing what they are doing.

Alternatively, some alignment procedures require the steering wheel to be centered when any adjustments are made or wheel alignment angle measurements of the vehicle are saved for future reference. During these procedures it is preferred that the steering wheel is centered with the operator in the vehicle, allowing them to judge the levelness of the steering wheel from a straight on view, as seen by a vehicle's driver, rather than at an angle as would be observed from the outside of the vehicle. Accordingly, the vehicle service system 100, configured with a machine vision sensor 200 can be configured with software instructions to determine if the operator is inside of the vehicle during a front toe adjustment procedure, and in particular, the operator's location at the point during the procedure where the steering wheel must be set to a level condition.

Operator safety is always a concern when utilizing vehicle service systems 100 and working around vehicles. For example, when a vehicle lift rack is raised or lowered (with or without a supported vehicle) it is important to ensure that an operator is not located under the lift or beneath any object supported by the lift, i.e. in a danger zone associated with the moving objects. Generally this is most likely to occur when only one operator is working around the vehicle. However, if there are other people around the lift as an operator directs the lift to raise or lower, it would be advantageous for the vehicle service system 100 to utilize the machine vision sensor 200 to provide a warning to the operator in the event a person is observed to be within the field of view 300 in a danger zone, or even for the vehicle service system 100 to stop the lift motion until the dangerous condition has been cleared.

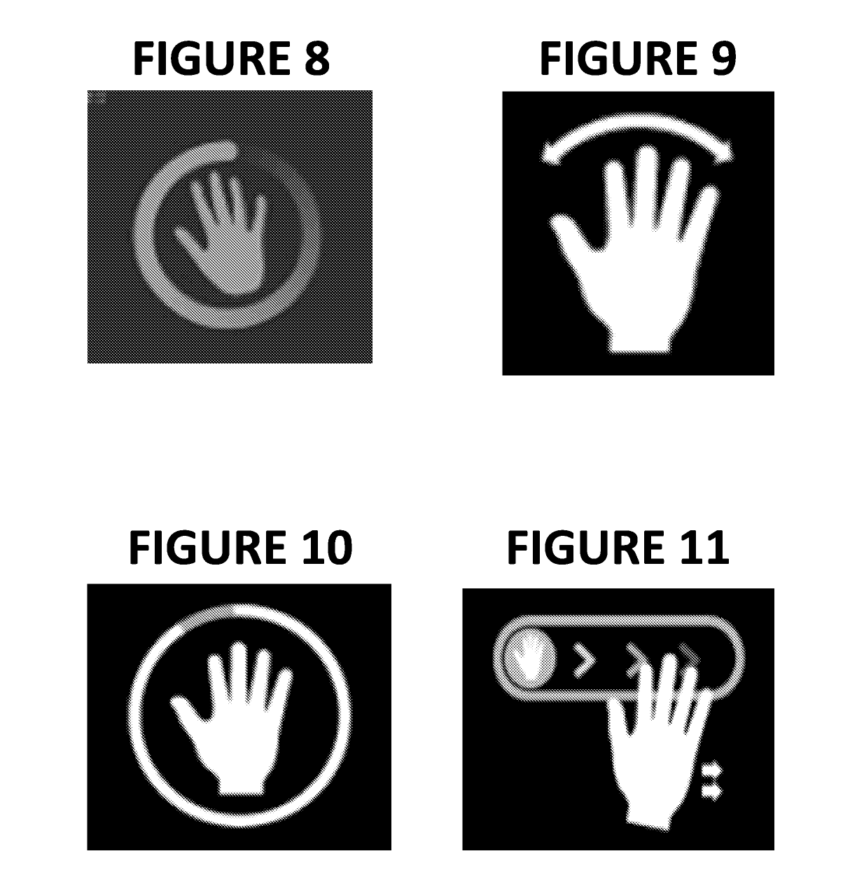

Vehicle service systems 100 often have multiple ways for an operator to provide control input, some which enable an operator to control the system remotely. Remote control methods commonly used with vehicle service systems 100 include the use of voice recognition (for spoken commands), and wired or wireless remote control devices. In one embodiment of the present disclosure, remote control of a vehicle service system 100 configured with a machine vision sensor 200 is accomplished by configuring the processing system 104 with software instructions to identify and recognize operator hand gestures, such as shown in FIGS. 8-11. Using the machine vision motion sensors, such as the Leap Motion Controller™ it is possible to identify specific motions made by human operators. Various gestures made by an operator, such as pointing, circular motions (FIG. 8), waving motions (FIG. 9), paused motion (FIG. 10), and swiping motions (FIG. 11) can be recognized and utilized to control various aspects of vehicle service system 100 in substantially the same manner as signals from conventional remote control devices, operator voice commands, or even as replacements for direct input traditionally provided via a mouse or touch-screen style interface.

For example, a common occurrence is when an operator is making an adjustment at the rear axle of the vehicle, which is generally the furthest point from a console of the vehicle service system 100, and there is a need to direct the vehicle service system 100 procedure to advance to the next step in a sequence. Instead of having to walk to the console, the operator can move a hand in a circular or waving motion within the field of view 300 of the machine vision sensor 200 to initiate a gesture recognition of a command by the vehicle service system 100. Once the gesture recognition has been activated, the operator can perform additional gestures, such as painting a “4” in the air to signify the equivalent of pressing an “F4” key on a keyboard or gesture a swipe motion left or right to move the vehicle service procedure to proceed one step forward or backward in a sequence of steps.

In addition to observing operators and human gestures, a vehicle service system configured with machine vision motion sensors can observe the positioning and placement of other objects within a field of view to determine if they are correctly positioned or if corrective action is required before proceeding with a vehicle service procedure. For example, machine vision vehicle wheel alignment service systems 100 use primary optical targets attached to the vehicle wheels to determine alignment measurements, together with secondary optical targets mounted to the vehicle to determine a ride height of the vehicle relative to the primary targets. It is important that the secondary targets be placed at the correct location on the vehicle undergoing service.

By employing a machine vision sensor 200, information associated with spatial depth within the field of view 300 is an additional data component of every pixel in the acquired images. With this added information, a primary optical target and a secondary optical target can be identified within image data acquire by a vehicle service system 100. Once the various targets are identified in the field of view 300, the spatial position of the secondary optical target and the spatial position of the primary optical target from the machine vision sensor 200 can be evaluated to verify the optical targets are properly positioned relative to each other to within a required tolerance. In the even the optical targets are determined to be improperly positioned within the field of view 300, the processing system 104 is configured with software instructions to issue a warning to the operator before proceeding with further measurements of the vehicle.

Operators of vehicle service equipment can typically get their hand very dirty.

Interacting with input devices such as keyboard, mouse and touch screen can damage those devices due to the dirt on the operator's hands. Using a using a machine vision sensor 200 such as the Leap Motion Controller™, the operator can be in front of the alignment console and move their fingers in front of the display to manipulate the mouse cursor without physically touching any of the input devices. This ability has the advantage of extending the usable time the input devices can be used by not damaging them with the dirt that may be on the operator's hands.

In addition to identifying operator location, operator gestures, operator postures and the placement of objects within a field of view, a vehicle service system 100 configured with a machine vision sensor 200 may be configured to utilize the image data received from the sensor 200 for purposes of operator identification. Vehicle service systems 100 typically provide operators with an option to log into the service system using a password or some other physical form of identification (i.e., a magnetic stripe card, key, etc.). Once the operator has logged in, the vehicle service system 100 verifies the operator's access, and optionally configures itself based on the operator's previously identified preferences. Using a machine vision sensor 200, such as a Kinect sensing device which is capable of facial recognition, enables the processor 104 configured with suitable software instructions, to identify an operator without the need for a physical form of identification, and can automatically reconfigure the system 100 as required based on stored preferences associated with the identified operator.

Data identifying an operator's spatial location in the field of view 300 relative to an object, such as a vehicle undergoing a service procedure, may be utilized by a vehicle service system 100 to adjust or alter information displayed to an operator on an associated graphical user interface. For example, using a machine vision sensor 200, such as the Kinect sensor previously described, a vehicle service system 100 may be configured to manipulate a virtual representation of a vehicle presented to an operator on a display, to correspond closely with the actual view of the vehicle as seen by the operator from the operator's current spatial location relative to the vehicle. Alternatively, the vehicle service system 100 may be configured with suitable software instructions to manipulate the displayed virtual representation in response to the movements of the operator relative to an associated display device. For example, if the operator moves to the right of the display device, a displayed virtual representation presented on the display may be rotated in the appropriate direction to present the operator with a virtual view as if the movement had been relative to the actual vehicle itself. i.e., if the operator crouches down, the virtual representation may be rotated upward to present the operator with a virtual view of the underside of the vehicle representation, as if the operator had crouched down to look under the actual vehicle itself. Such virtual representations are not limited to representations of an entire vehicle, and may, in fact, be representations of various vehicle components such as may require adjustment during a vehicle service procedure. In such cases, the observation by the vehicle service system 100 of the operator's location and/or movements in the field of view 300 relative to the display device may be utilized to alter the virtual representation of the various vehicle components as if the operator was moving relative to those specific components on the vehicle.

Data identifying an operator's spatial location in the field of view 300 relative to an object, such as a vehicle undergoing a service procedure, may be utilized by a vehicle service system 100 to send supplemental information to a wearable display device, such as Google Glasses™, that is relevant to where the operator is located. For example, if the operator is under the vehicle at the right rear wheel the vehicle service system 100 and the vehicle service system is at a point in the alignment procedure where measurement information is displayed, specific live measurement information could be sent to the wearable display device or supplemental information such as the specifications could be sent. The information would be specific to the location of the operator and the location of the alignment procedure. If the alignment procedure was at a point in the procedure where an inspection was being performed, part information for the right rear of the vehicle would be sent to the wearable display device. Other supplemental information that may be sent to a wearable display device include live bar graphs, compensation position, tire tread depth measurements, tire air pressure, warning indications, alignment sensor status, balancer “tagged” wheels for positioning of tires on the vehicle, replacement part information such as manufacturer, price and part number, customer information and customer “live” view of them as the operator discusses what they have found on their vehicle.

The present disclosure can be embodied in-part in the form of computer-implemented processes and apparatuses for practicing those processes. The present disclosure can also be embodied in-part in the form of computer program code containing instructions embodied in tangible media, or another computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A vehicle service system having a processing system configured with vehicle service software for carrying out at least one vehicle diagnostic or service procedure, comprising:
at least one machine vision sensor coupled to said processing system and configured to produce spatial or topographical image data, the machine vision sensor including
a projection system configured to project at least one optical pattern of discrete points onto surfaces of objects within a field of view,
an associated imaging sensor which is configured to acquire images of said projected pattern on said surfaces, and
an image processor configured with software instructions to identify elements of said optical pattern within said acquired images to generate said spatial or topographical image data representative of observed objects within said field of view for communication to said processing system; and
wherein said processing system is configured with software instructions to utilize said generated spatial or topographical image data representative of observed objects during said vehicle diagnostic or service procedure to determine at least one spatial parameter associated with said surfaces.

2. The vehicle service system of claim 1 wherein said discrete points of said at least one optical pattern are uncorrelated over a functional depth range of said associated imaging sensor.

3. The vehicle service system of claim 1 wherein said optical pattern of discrete points is a random speckle pattern.

4. The vehicle service system of claim 1 wherein said surface onto which said optical pattern is projected is associated with a vehicle wheel assembly.

5. The vehicle service system of claim 4 wherein said at least one spatial parameter is associated with at least one vehicle wheel alignment angle.

6. The vehicle service system of claim 5 wherein said vehicle service system is a vehicle inspection system, and wherein said processing system is configured with vehicle service software for carrying out a vehicle wheel alignment angle audit using said at least one vehicle wheel alignment angle.

7. The vehicle service system of claim 4 wherein said at least one spatial parameter is a surface topography of at least a portion of a wheel rim component of said vehicle wheel assembly.

8. The vehicle service system of claim 7 wherein said surface topography includes a surface contour across said portion of said wheel rim component.

9. The vehicle service system of claim 4 wherein said at least one spatial parameter is a tread depth topography for at least a portion of a tire component of said vehicle wheel assembly.

10. The vehicle service system of claim 1 wherein said surface onto which said optical pattern is projected is associated with a vehicle body panel and wherein said at least one spatial parameter is a vehicle ride height measurement.

11. The vehicle service system of claim 1 wherein said surface onto which said optical pattern is projected is associated with a vehicle support structure including, but not limited to, a lift rack, a support runway, and a ground surface; and
wherein said at least one spatial parameter is associated with a spatial position and orientation of the vehicle support structure.

12. The vehicle service system of claim 1 wherein said surface onto which said optical pattern is projected is associated with an articulated tool such as, but not limited to, a tire bead breaker arm, a tire mount/dismount tool, a load roller, or a protective guard.

13. The vehicle service system of claim 1 wherein said projection system configured to project at least one optical pattern at a wavelength which is invisible to a human operator.

14. The vehicle service system of claim 1 wherein said processing system is configured with software instructions to utilize said generated spatial or topographical image data representative of said observed objects within said field of view to identify movement of said observed objects.

15. The vehicle service system of claim 14 wherein said observed objects include a human operator, and wherein said identified movement represents an operator instruction.

16. The vehicle service system of claim 1 wherein said processing system is configured with software instructions to utilize said generated spatial or topographical data to identify object features within the field of view, including, but not limited to, vehicle wheel assembly rim damage, tire valve stem locations, installed imbalance correction weights, vehicle body panel damage, and a foreign object embedded in a tire tread surface.

17. The vehicle service system of claim 1 wherein said associated imaging sensor consists of a single sensor secured in a fixed position and orientation relative to a source of said projected pattern within said projection system.

18. The vehicle service system of claim 1 wherein said associated imaging sensor is a stereoscopic imaging sensor having a plurality of image sensing elements.

19. A method for measuring alignment of a wheel assembly on a vehicle, comprising:
disposing the vehicle such that at least one wheel assembly is within a field of view of a range imaging machine vision sensor;
projecting, from said range imaging machine vision sensor, a pattern of illuminated points onto the surfaces of the vehicle, said surfaces including said at least one wheel assembly;
acquiring an image of said projected pattern from a single sensor secured in a fixed position and orientation relative to a source of said projected pattern;
processing said acquired image to identify topographical data associated with at least said wheel assembly; and
utilizing said identified topographical data to determine one or more alignment angles for said at least one wheel assembly.

20. A method for measuring a surface profile for at least a portion of a wheel rim of a wheel assembly, comprising:
disposing the wheel assembly such that at least a portion of the wheel rim surface is within a field of view of a range imaging machine vision sensor;
projecting, from said range imaging machine vision sensor, a pattern of illuminated points onto the portion of the wheel rim surface;
acquiring an image of said projected pattern from a single sensor secured in a fixed position and orientation relative to a source of said projected pattern;
processing said acquired image to identify topographical data associated with said portion of the wheel rim surface; and
utilizing said identified topographical data to map a contour or surface profile of the observed portion of the wheel rim surface.

21. A vehicle service system for use by an operator to carry out one or more service procedures associated with a vehicle, having an operator interface and a processing system configured to interact with the operator through the operator interface and to carry out said one or more service procedures, comprising:
at least one machine vision sensor operatively coupled to the processing system, the machine vision sensor having a field of view encompassing at least a portion of a vehicle service area to obtain one or more images there of;
a means for processing images obtained by said at least one machine vision sensor to identify one or more human features with said field of view; and
wherein said processing system is further configured to utilize said identified human features within said field of view in association with said one or more service procedures.

22. The vehicle service system of claim 21 wherein said at least one machine vision sensor is configured with a depth sensor including an infrared laser projector combined with a CMOS image sensor configured to capture video data in 3D under ambient light conditions.

23. The vehicle service system of claim 21 wherein said one or more service procedures include at least one of a vehicle wheel alignment procedure, a vehicle wheel balancing procedure, a vehicle tire changing procedure, a vehicle diagnostic procedure, a vehicle component replacement procedure, or a vehicle engine analysis procedure.

24. The vehicle service system of claim 21 wherein said one or more identified human features include operator facial features, operator hand gestures, operator postures, and operator location relative to other objects present in the field of view.

25. The vehicle service system of claim 21 wherein said processing system is configured to utilize said identified human features in association with said one or more service procedures to monitor operator actions during said service procedures.

26. The vehicle service system of claim 25 wherein said processing system alters said one or more vehicle service procedures in response to a monitored operator action.

27. The vehicle service system of claim 25 wherein said processing system provides operator warnings and/or operator procedural guidance through said operator interface in response to a monitored identified operator action.
